(19) United States
(12) Patent Application Publication
(10) Pub. No.: US 2009/0254436 A1
(43) Pub. Date: Oct. 8, 2009

(54) METHOD AND SYSTEM FOR MANAGING DELIVERY OF LEADS TO A BUSINESS

(75) Inventor: Paul Dagum, Los Altos Hills, CA (US)

Correspondence Address: HUSCH BLACKWELL SANDERS LLP, 190 Carondelet Plaza, Suite 600, ST. LOUIS, MO, 63105, US

(73) Assignee: Business.com, Santa Monica, CA (US)

(21) Appl. No.: 12/477,656

(22) Filed: Jun. 3, 2009

(51) Int. Cl. G06Q 30/00

(52) U.S. Cl. 705/14.48

(57) ABSTRACT

A system and method that enables a business owner to receive leads such as phone calls or emails to their business at a prescribed cost-per-lead and a volume determined by the budget the owner is willing to allocate to the purchase. The method manages an internet based advertisement campaign, which includes performing the step of creating an internet based advertisement campaign that includes a budget parameter, a campaign duration parameter, advertisement content with a lead reference, and an ad listing with a URL that links to said advertisement content. The ad listing can be syndicated to a plurality of internet sites. The method can include the step of monitoring the leads received by the advertiser from each lead reference and decrementing the campaign budget for each click on the ad listing URL by the product of the cost-per-lead and the advertisement's conversion rate of clicks to leads. The method can further include the step of purchasing traffic from search engines to the advertisement to generate leads and spend any remaining budget.

### BACKGROUND OF INVENTION

1. Field of Invention

This invention relates generally to managing pay-per-click internet based marketing campaigns and, more particularly, to performance base advertisement for maximizing delivery of leads to a business and return on investment for such campaigns.

2. Background Art

Pay-per-click (PPC) advertising revolutionized direct marketing to consumers on the internet. GoTo (subsequently Overture and acquired by Yahoo) was one of the first to introduce the concept of PPC advertising. Today PPC is fundamental to the monetization of search-engine results and fundamental to driving qualified traffic to websites. E-commerce sites and large brand sites were the first to adopt PPC as a marketing strategy while small and medium sized businesses have been slow to move in that direction. A small business values direct customer interaction through a phone call or email, and regards a click to a website as only the first step in the sale conversion funnel. Measuring the conversion from clicks to calls as well as understanding the conversion of calls to customers realized is necessary to properly manage the PPC campaign and ensure positive return-on-advertiser-spend (ROAS). This places the burden on the small business owner to collect data and run complex analytical calculations on a regular basis. If the calculations are flawed because of lack of data or scarcity of quality data, the business owner may overspend for traffic that does not deliver ROAS or underspend and not receive any traffic.

The primary challenge with PPC for a small business is that the business owner is interested in leads, such as phone calls, emails, filled out lead forms requesting services, and less interested in website clicks. The pay-per-click model has been modified to other models, for example, the pay-per-call (PPCall) model by Ingenio where a business sets up a campaign similar to a PPC campaign but is bidding for calls not clicks. While these models may be more attractive to the small business owner, these models do not solve their problem of providing visibility into the call volume (or lead volume) that will be delivered and the effective cost-per-lead incurred. In addition, leads are delivered in unpredictable bursts that can overwhelm a small business owner's ability to process them and results in waste.

From the perspective of a small business owner what is needed is a method and a system that provides predictable lead volume and price transparency of the effective cost-per-lead. What is further needed is a method and system that delivers the leads consistently throughout the duration of the campaign.

### BRIEF SUMMARY OF INVENTION

The invention enables a business owner to receive leads such as phone calls or emails to their business at a prescribed cost-per-lead and a volume determined by the budget the owner is willing to allocate to the purchase. The method and system of the present invention provides the ability to provide price transparency in the cost-per-lead (e.g., cost-per-call) that can be expected based on business type and location and specify a budget, for example a monthly budget, that the business is willing to spend. Based on these two inputs the business can expect to receive on-average as many leads as the business's budget divided by the cost-per-lead.

One embodiment of the present invention is a method for managing an internet based advertisement campaign, which includes performing the step of creating an internet based advertisement campaign that includes a budget parameter, a campaign duration parameter, advertisement content with a lead reference, and an ad listing with a URL that links to said advertisement content. The ad-listings can be syndicated to a plurality of internet sites. The method can include the step of monitoring the leads received by the advertiser from each lead reference and decrementing the campaign budget for each click on the ad listing URL by the product of the cost-per-lead and the advertisement's conversion rate of clicks to leads. The method can further include the step of purchasing traffic from search engines to the advertisement to generate leads and spend any remaining budget.

Optionally the ad listing can also contain a lead reference, distinct from the lead reference of the advertisement and the method can further comprise the steps of monitoring of the leads received by the advertiser from the ad-listing lead reference and decrementing the campaign budget by a cost-per-lead amount for each lead received from the ad-listing lead reference, wherein a lead reference is a phone number or email address. Leads can comprise any of phone calls, text messages, emails, digital lead forms, or facsimile lead forms. If multiple ad listings are displayed the computer implemented method can further order the ad listings based on their performance, consumed budget, remaining budget, and remaining campaign duration. The computer implemented method can further report on the number of leads delivered and budget consumed.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 illustrates an embodiment of the lead-delivery system configured in accordance with the present invention,

FIG. 2 is a functional description of the system in accordance with one embodiment of the present invention,

FIG. 3 illustrates an exemplary computing environment of the lead-delivery system configured in accordance with one embodiment of the present invention,

FIG. 4 is the campaign creation module in accordance with one embodiment of the present invention,

FIG. 5 is the internet distribution module in accordance with one embodiment of the present invention,

FIG. 6 is the purchased traffic module in accordance with one embodiment of the present invention,

FIG. 7(a)-(b) are the optimization module in accordance with one embodiment of the present invention,

FIG. 8(a)-(c) are the reporting module in accordance with one embodiment of the present invention; and

FIG. 9(a)-(b) are the pricing module in accordance with one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

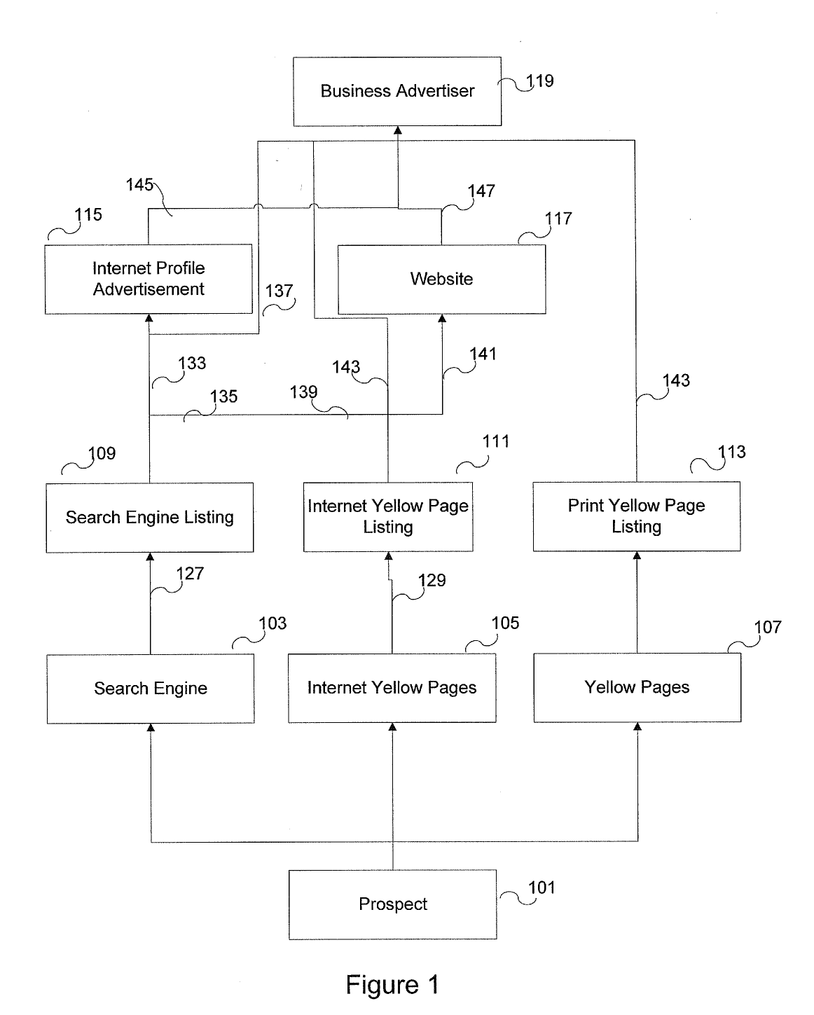

According to the embodiment(s) of the present invention, various views are illustrated in FIG. 1-9 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

The following detailed description of the invention contains many specifics for the purpose of illustration. Anyone of ordinary skill in the art will appreciate that many variations and alterations to the following details are within scope of the invention. Accordingly, the following embodiments of the invention are set forth without any loss of generality to, and without imposing limitations upon, the claimed invention.

One embodiment of the present invention comprises a system and method that enables a business owner to receive leads such as phone calls or emails to their business at a prescribed cost-per-lead and a volume determined by the budget the owner is willing to allocate to the purchase, which teaches a novel system and method for managing an internet based advertisement campaign, which includes performing the step of creating an internet based advertisement campaign by entering data into a computer that includes a campaign targeting information parameter, a campaign distribution information parameter, a campaign budget information parameter, a campaign duration parameter, an advertisement with a lead reference, and an ad listing with a URL that links to said advertisement content. The method can include the step of formulating a cost-per-lead parameter based on geographic, category and attribute targeting selected from geographic, category and attribute taxonomies. The ad listing can be syndicated to a plurality of internet sites. The method can include the step of monitoring the leads received by the advertiser from each lead reference and decrementing the campaign budget for each click on the ad listing URL by the product of the cost-per-lead and the advertisement's conversion rate of clicks to leads. The method can further include the step of purchasing traffic from search engines to the advertisement to generate leads and spend any remaining budget.

Another embodiment of the invention can be a computer system including a processor, a memory unit operable for storing a computer program, an input mechanism operable for inputting data into said computer system, an output mechanism for presenting information to a user, a bus coupling the processor to the memory unit, input mechanism and output mechanism, wherein the computer system includes various executable program modules stored thereon where when executed are operable to perform functions. The computer system can comprise campaign creation program module stored on said computer system where when executed allows a user to create an advertising campaign by entering data into the computer system where said data includes campaign details for a campaign targeting information parameter, a campaign distribution information parameter, a campaign budget information parameter, a campaign duration parameter, an advertisement with a lead reference, and an ad listing with a URL that links to said advertisement.

An optimization module can also be stored on said computer system where when executed formulates a cost-per-lead parameter based on geographic, category, lead type, originating source and attribute targeting selected from geographic, category and attribute taxonomies. An internet distribution program module can be stored on said computer system where when executed allows the user to syndicate the ad listing to a plurality of internet sites. The user can select the partner properties or internet sites for syndicating using this program function. A reporting program module can allow the user to monitor the leads received by the advertiser from each lead reference after the campaign has been set up. An optimization program module stored on said computer system where when executed can decrement the campaign budget for each click on the ad listing URL by the product of the cost-per-lead and the advertisement's conversion rate of clicks to leads. A purchased traffic program module stored on said computer system where when executed can allow the user to purchase traffic from search engines to the advertisement to generate leads and spend any remaining budget.

The ad listing can contain an ad lead reference, distinct from the lead reference of the advertisement. A reporting program module can be stored on said computer system where when executed allows the user to monitor the leads received by the advertiser from the ad-listing lead reference. Further, an optimization program module can be stored on said computer system where when executed decrements the campaign budget by a cost-per-lead amount for each lead received from the ad-listing lead reference. The lead reference can be a phone number or email address. The leads can be selected from a group consisting of phone calls, text messages, emails, digital lead forms and facsimile lead forms, wherein if multiple ad listings are displayed by the reporting program module the purchased traffic module is further operable to order the ad listings based on their performance, consumed budget, remaining budget, and remaining campaign duration. The reporting program module can be further operable to report on the number of leads delivered and budget consumed.

The advertising campaign data entered can include campaign details for a business name parameter, a business location parameter, a tag line, and a brief description of the business including any key areas of specialization. The campaign data entered can be used for constructing the ad listing that is displayed on the internet site and used for constructing a business profile. The campaign can include reporting estimates of the number of leads to expect from. The campaign can further comprise geography, category and attribute mapped to a target found to generate traffic where said target is purchasable for a search marketing source, where said purchasable target is keyworded with a set of keyphrases that are descriptive of the target's geography, category and attribute such that when a user selects a geography, category and attribute during campaign creation, the ad for the target inherits the purchasable targets and keyphrases.

The details of the invention and various embodiments can be better understood by referring to the figures of the drawing. Referring to FIG. 1, which illustrates an embodiment of the lead delivery system configured in accordance with the present invention, and which is not intended to limit scope as one of ordinary skill would understand on review of this application that other configurations could be utilized without departing from the scope of the claimed invention. A prospect 101 may represent an internet user or an off-line prospect with access to print advertising such as the yellow pages. The prospect is exposed to the business owner's advertisement (or listing) through multiple venues which include the use of a search engine 103, the use of an internet yellow pages site 105, or use of print yellow pages 107. When the prospect is exposed to the business owner's search engine listing 109 through an internet connection 127, that prospect may be given the options to (i) click-to-a-profile advertisement 133 which takes the prospect to the business owner's internet profile advertisement 115 containing further information about the business and contact information, (ii) click-to-a-website 135 which takes the prospect to the business owner's website 117 containing further information about the business and contact information, and/or (iii) establish direct communication 137 with the business owner 119 through a phone call using the number listed in the search engine listing 109.

When the prospect is exposed to the business owner's internet yellow page listing 111 through an internet connection 129, that prospect may be given the options to (i) click-to-a-profile advertisement 139 which takes the prospect to the business owner's internet profile advertisement 115 containing further information about the business and contact information, (ii) click-to-a-website 141 which takes the prospect to the business owner's website 117 containing further information about the business and contact information, and (iii) establish direct communication 143 with the business owner 119 through a phone call, email address, or text message using the number or email listed in the listing 111.

When the prospect is exposed to the business owner's print yellow page listing 113, that prospect may be given the options to establish a direct communication 143 with the business owner 119 through a phone call using the number listed in the yellow page listing 113. The prospect may also be provided with the URL of the business owner's website whereby the user can enter the URL into a browser application of a personal computing device having access to the internet. When the prospect is exposed to the business owner's profile from either a search engine listing or a yellow page listing, the prospect is given the option to establish direct communication 145 with the business owner 119 through a phone call, email address, or text message using the number or email listed in the profile 115. When the prospect is exposed to the business owner's website from either a search engine listing or a yellow page listing, the prospect is given the option to establish direct communication 147 with the business owner 119 through a phone call, email address, or text message using the number or email listed in the profile 117.

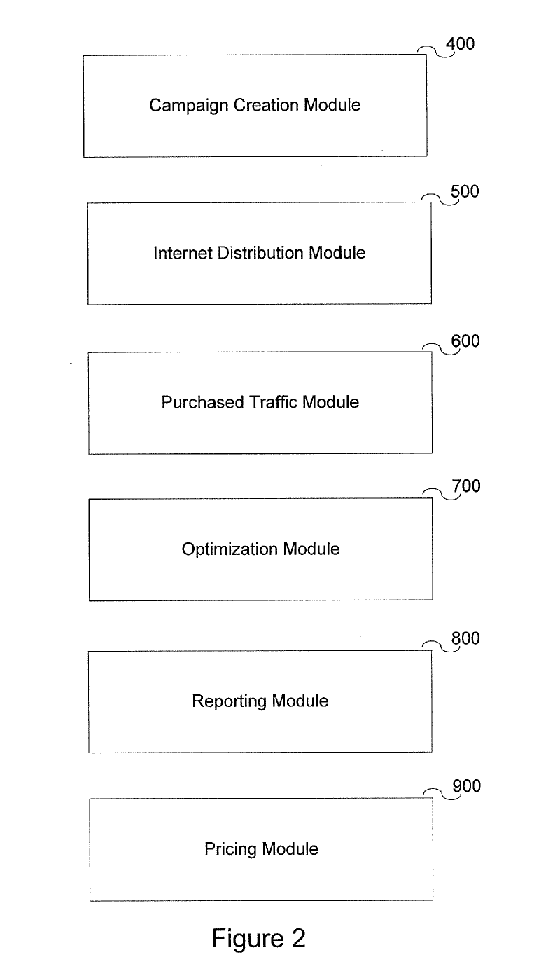

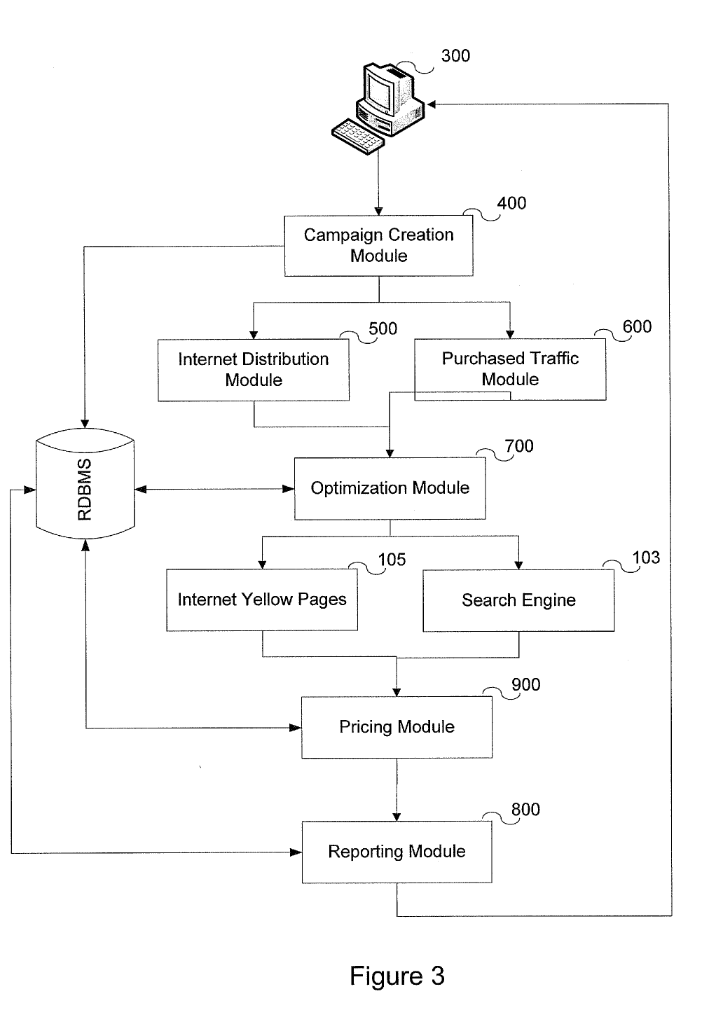

FIG. 2 illustrates an embodiment of the functional description of the system configured in accordance with the present invention and is not intended to limit scope as one of ordinary skill would understand on review of this application that other configurations could be utilized without departing from scope of the claimed invention. Referring to FIG. 3, a user interacts with the campaign creation module 400 to create an advertising campaign in the system for delivery of leads to the user's business. The internet distribution module 500, the purchased traffic module 600, and the optimization module 700 are responsible for executing the campaigns created in module 400. The user can track the performance of the campaign in the reporting module 800 that displays leads delivered to the business compared to the estimated lead number and the budget consumed. The pricing module 900 computes the fair-market value of the any non-lead actions generated by modules 500 or 600 using as input an established cost-per-lead (CPL). Both the CPL and the pricing from the pricing module are used by the optimization module and also used to decrement the advertisers budgets for leads or actions generated by their campaign.

The CPL values depend on the specific geo-vertical and the lead type, and the computation uses multiple data sources to triangulate to a geo-vertical CPL. The data sources for triangulating include (i) Google and Yahoo! cost-per-click data, (ii) internet yellow pages cost and conversion data, and (iii) market research on competitive CPLs. Each data source generates an initial value for the CPL. For example, triangulating to compute the cost-per-call using Google cost-per-click data for the vertical “attorneys” and geography “Chicago”, the system would sum the total cost to purchase traffic on Google to “Chicago-attorney” business profiles and then divide that cost by the total number of calls that were generated. Note that other lead types, such as filling out a lead-form yield a different CPL value because the conversation rate differs. Similarly other traffic sources yield different values because both the cost to purchase traffic and the lead conversion rate for that traffic differ. To combine the various data sources into a single CPL for a specific lead type, each data source is weighted by the relative volume of leads delivered by each source. This weighting approach is similar to the weighting of Paashe or Laspeyres consumer price indices by the market share of the goods. As proxy to these weights the systems uses the relative volume of traffic an individual source represents among all of the data sources. This proxy is valid under the assumption that higher traffic correlates with higher lead delivery volume to business owners.

FIG. 3 illustrates an embodiment of the computing environment of the system configured in accordance with the present invention and is not intended to limit scope as one of ordinary skill would understand on review of this application that other configurations could be utilized without departing from scope of the claimed invention. Referring to FIG. 3, a business owner interacts with the campaign creation module 400 through a computer terminal 300 to create the advertising campaign. The details of the campaign creation are persisted in the relational database management system 302 and communicated to internet distribution module 500 and purchased traffic module 600. These two modules communicate with the optimization module 700 to syndicate the ad listing to internet yellow pages 105 and search engine 103, respectively. User activity such as clicks, calls, emails, or send-to-phone are tracked and priced by the pricing module 900 to properly decrement the business owner's budget and compensate the syndication partner. This activity is persisted in the relational database management system 302, and then communicated to reporting module 800 together with the ad-listing views and the details of those views such as property, listing rank, and taxonomy node or search query. The reporting module persists all this information and prepares the report that is made available to the business owner through computer terminal 200.

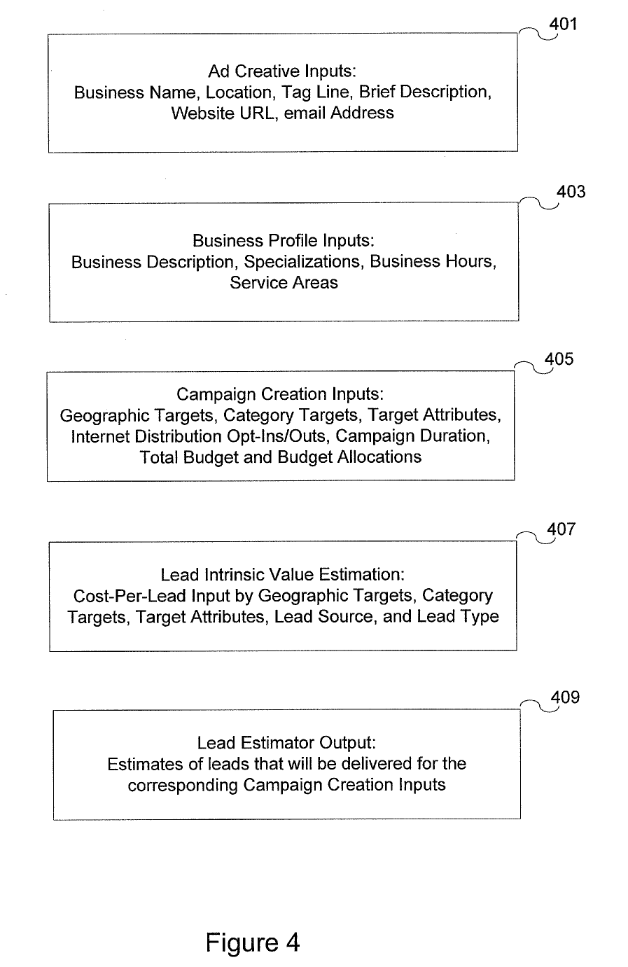

FIG. 4 illustrates an embodiment of the campaign creation module configured in accordance with the present invention and is not intended to limit scope as one of ordinary skill would understand on review of this application that other configurations could be utilized without departing from the scope of the claimed invention. Referring to FIG. 4, a user enters the details of the advertising (ad) creative in 401. By way of example, these details might include the business name, business location, a tag line for the business, and a brief description of the business including any key areas of specialization. These inputs are used to construct the ad creative (or ad listing) that is displayed on partner internet properties by the internet distribution module 500 illustrated in FIG. 3. If the business has a website and email contact information, the user can also enter the website URL and email address in 401. Tracking-phone numbers, which are numbers that a third party can track calls made to those numbers, is assigned to the ad listing by the system. The number of tracking-phone numbers assigned depends on the number of internet properties used to display the listing.

In 403, the business user enters more detailed business information that is used to construct the business profile. The business profile is a set of one or more tabbed html pages that are displayed when an internet user clicks on ad listing title to read more information about the business. The additional information may include a full business description, all areas of specialization, business hours, business reviews, and service areas for service businesses. If a website URL or email address was entered in 401 it will also appear in the business profile. Tracking numbers distinct from those assigned to the ad listing are assigned to the business profile to enable tracking of calls generated from the business profile.

In 405, the business user enters details needed to construct the advertising campaign. The details entered can include campaign targeting information, campaign distribution information, campaign budget information, and campaign duration information. The targeting information includes geographic targeting, category targeting, and attribute targeting selected from geographic, category, and attribute taxonomies. The geographic targeting can be very broad such as nation-wide, or very specific such as a zip-code or neighborhood. Multiple geographic targets can be selected in one campaign. Similarly, the multiple category and attribute targets can be selected in one campaign. For example, a surgeon may select cardiac surgery, thoracic surgery, and vascular surgery as target categories and under cardiac surgery may select attributes heart transplantation. The internet distribution selection enables the business user to opt-out of certain internet properties from the set of network properties which the present invention uses to display ads. For example, the surgeon may not want her ads shown on a property catering to cosmetic surgeons. The user also enters the campaign duration, total campaign budget, and percent allocation of the budget to each campaign target. The user can enter multiple campaigns for example if the campaigns are designed to run over a year duration but with monthly budgets.

The present invention gets as input the Cost-Per-Lead (CPL) in 407. A lead is a direct contact between an internet user and the business user through one of the touch points displayed in the ad listing, the business profile, or the website. These include, for example, an email, a call, a text message, a lead form with a return email address or phone number. The CPL varies with the geographic, category, and attribute targeting because business users are willing to pay more for certain leads that generate a higher revenue return. For example, a law firm will pay more for personal injury leads than for intellectual property leads. The CPL can also vary by the lead type. For example, a mortgage broker will pay more for a completed mortgage lead form than for an email requesting information. Lastly, the CPL can also vary by the originating source such as ad listing, business profile, or website. A lead from a website might be considered a more qualified lead because the internet user has consumed more knowledge regarding the business before contacting it. Once the user has completed the campaign creation, in 409 the user can view estimates of the number of leads to expect from that campaign.

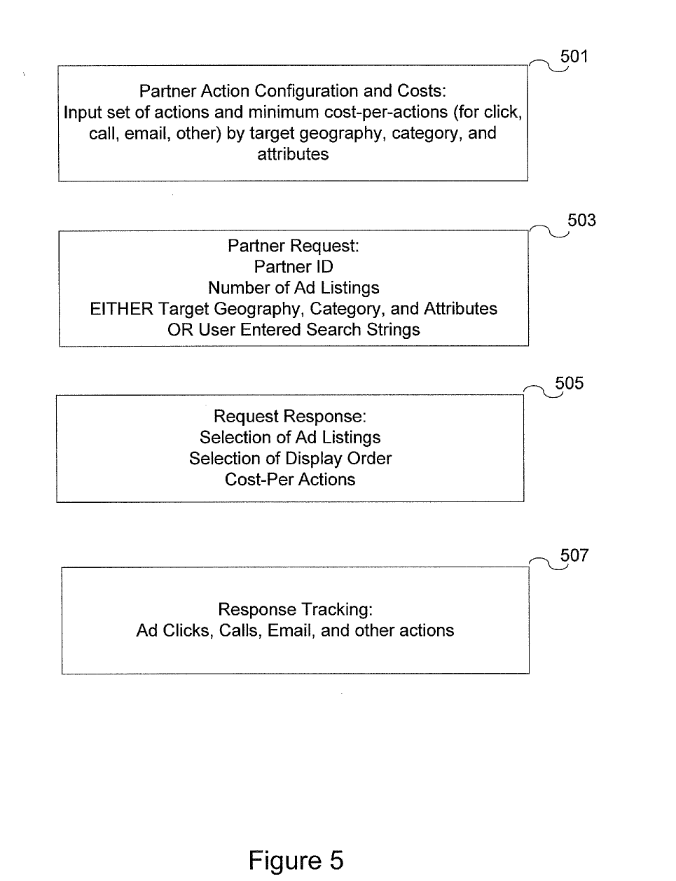

FIG. 5 illustrates an embodiment of the internet distribution module configured in accordance with the present invention and is not intended to limit scope as one of ordinary skill would understand on review of this application that other configurations could be utilized without departing from the scope of the claimed invention. Referring to FIG. 5, in 501 the present invention gets as input the set of actions in the ad listings that are displayed by partner property and the minimum costs for those actions that are specific to the geography, category and attribute taxonomy. A partner, for example, may not want to display ad listings with tracking numbers and that action would be removed from the ad listings displayed on that property. The remaining actions would have costs determined in accordance with the partner and those costs would be inputs to the present invention.

The interaction between the partner property and the present invention involves a partner request initiated by a page view on the partner site 503, a response to that request from the host system of the partner internet site is generated by the present invention 505, and tracking of the internet user's actions on receipt of the response 507. In message 503, the page view that initiates the request must pass to the present invention (i) a partner id that identifies the partner source, (ii) EITHER the taxonomy geography, category and attributes of the page view OR one or more search strings entered by the internet user that the present invention can map to a taxonomy geography, category and attributes, and (iii) the number of ad listings requested.

When the present invention receives message 503, it responds with message 505 that contains ad listings not exceeding the number requested and each ad listing configured in accordance with the partner requirements. Message 505 also contains the ad listing display order that defines the order in which the ad listings are arranged on the partner page. Lastly message 505 contains the cost-per-action that complies with the minimum CPAs set in 501. Note that the determination of the ad listings to show, the display order, and the cost-per-actions is computed by the optimization module 700 in reference to FIG. 3.

Once the page is rendered for the internet user, that user interacts with the ad listings through navigational clicks, calls, or other available actions. Each of those actions is captured in message 507 sent back to the present invention. The actions are used for accounting purposes to determine payment to the partner and, in reference to FIG. 3, to optimize future response messages in 800 and to decrement the advertisers budget in 900.

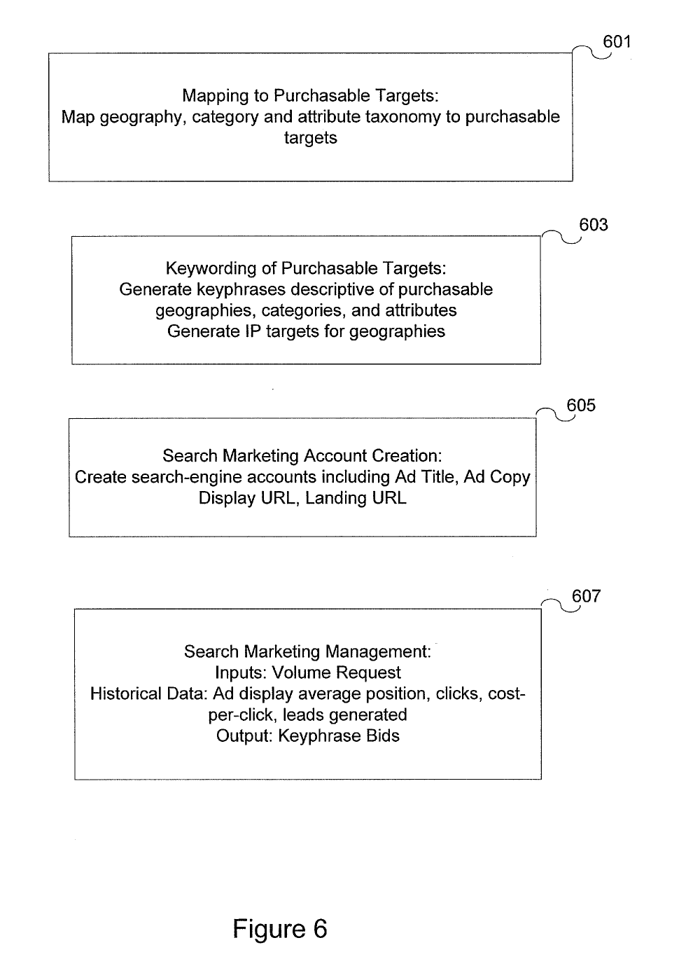

FIG. 6 illustrates an embodiment of the purchased traffic module configured in accordance with the present invention and is not intended to limit scope as one of ordinary skill would understand on review of this application that other configurations could be utilized without departing from the scope of the claimed invention. The present invention purchases traffic to ad listings and/or business profiles when insufficient traffic is received from the sum-total of all other sources to consume the budgets or when the optimization module determines that it is optimally beneficial to purchase more traffic to a particular business.

Referring to FIG. 6, in 601 the taxonomy geographies, categories, and attributes are mapped to targets that are purchasable for each search marketing source. Not all taxonomy combinations of geography, category, and attributes generates meaningful traffic and these must be mapped to those that do generate traffic. That mapping is dependent on the search marketing source.

In 603, each purchasable target must be keyworded with a set of keyphrases that are descriptive of the target's geography, category, and attributes. When a business user selects a geography, category and attribute target during campaign creation, the ad for that target inherits the purchasable target(s) and the keyphrases defined in 601 and 603. In addition to geographic targeted keyphrases, the internet user's IP can be used to target geographies in 603.

In 605 search marketing accounts are created for the purchasable targets by programmatically or manually entering ad title, ad copy, display URL and landing URL that conform to the search marketer's specifications. For a specific purchasable target, separate accounts can be created for each business in which case the landing URL corresponds to the URL of the business profile for each business. Alternatively, only a single account is created for that purchasable target and the landing URl points to a generic profile that is instantiated by the present invention to a different business profile depending on the optimization needs determined by the optimization module.

To complete the account creation, bids must be computed for each keyphrase defined in 603. The bids depend on the volume of traffic requested by the present invention to supplement a traffic shortfall from the other sources. In addition, the bids depend on the historical performance of the ad by keyphrase. Using the historical data available that includes the search marketing ad display position, clicks generated, cost-per-click (as distinct from bid submitted), and leads generated from the business profile receiving the traffic, together with the traffic volume requested, 607 computes bids for the keyphrases for that account that delivers the requested volume. By way of example, consider an account containing a portfolio of two keywords “lawyers” and “attorneys”. The computation of the bids begins by computing the cost-volume elasticity curve for each keyword. In practice, these curves are convex with increasing slope as the volume increases, significant of the increasing incremental cost to acquire traffic at higher baseline volumes. The slope of the elasticity curve at a given volume is the marginal cost to acquire additional traffic for that keyword. The bid computation first solves for the volumes V(k) for each keyword k where all the marginal costs are equal and where the sum of these volumes equals the volume requested. The bid computation then solves for the bids necessary to deliver the keyword volumes V(k) for each keyword using the bid-volume elasticity curves for those keywords. The bids computed by this method achieve the lowest total purchased traffic cost that delivers the volume requested.

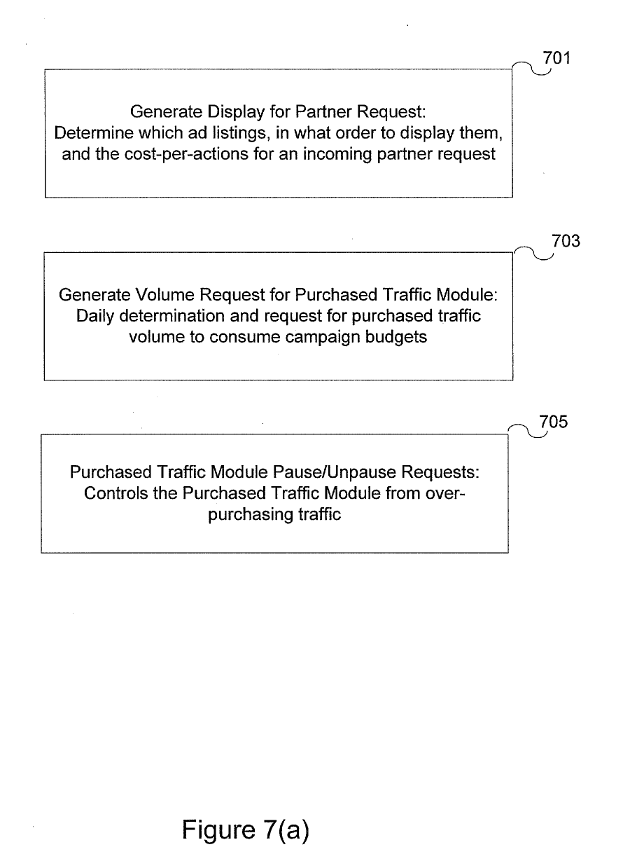

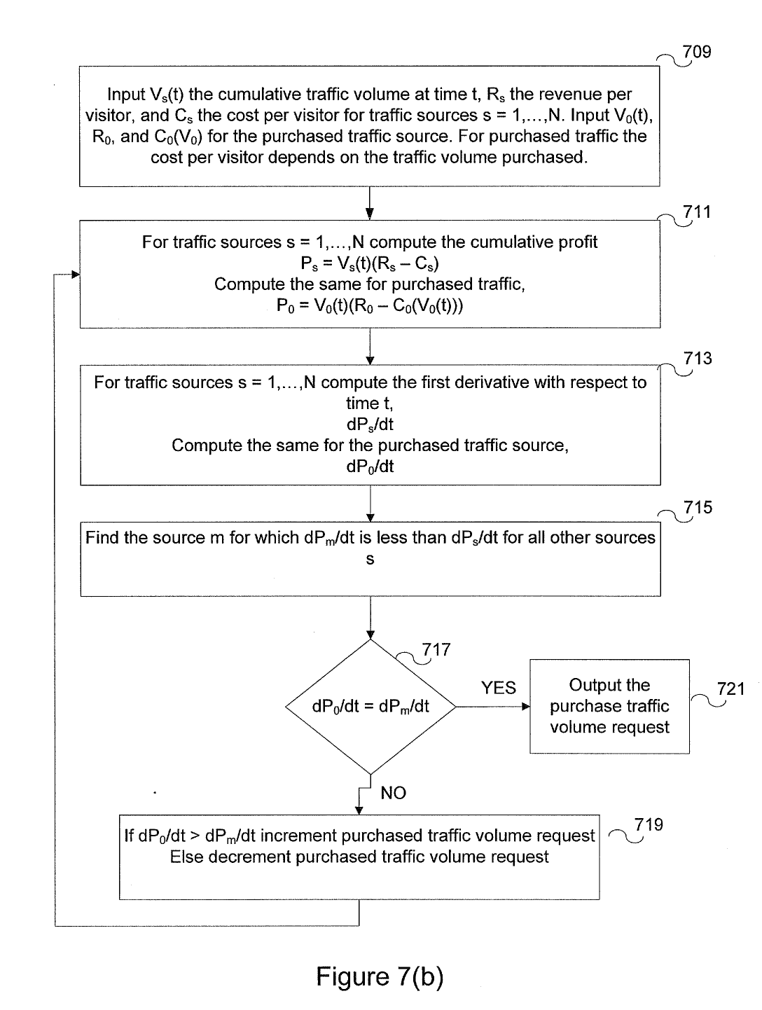

FIG. 7(a)-(b) illustrate an embodiment of the optimization module configured in accordance with the present invention and is not intended to limit scope as one of ordinary skill would understand on review of this application that other configurations could be utilized without departing from the scope of the claimed invention. Referring to FIG. 7(a), 701 selects the set of ad listings, the display order, and the cost-per-actions used to compose a response message 505 in reference to FIG. 5. The computation of which ad listings to display, their display order and their cost-per-action is designed to consume the budget smoothly and maximize the profit over the campaign duration. This computation uses as inputs the total budget and the available budgets for all ad listings that are eligible for the request message 503, the ad listings historical conversion to clicks or leads by action type and display rank, the conversion to leads on the business profile or website from ad-listing clicks redirecting to the business profile or website, and the remaining campaign duration.

The optimization module is also responsible for computing the traffic volume request that is input to 607 of the purchased traffic manager referenced in FIG. 6. In 703, a traffic volume request is computed for each business campaign to supplement any short fall in leads and budget consumption delivered by the sum-total of all other sources. The volume request is computed at set time intervals. The computation uses as input the total budget and the available budget of a campaign, the conversion to leads on the business profile or website from purchased clicks redirecting to the business profile or website, the remaining campaign duration, the historically delivered volume for a given volume request, the historical pause request times for a given volume request, and the target pause time defined as the time of day at which an business' campaign should have received its daily lead traffic. Note that the latter depends on the business' hours of operation.

In 705, pause requests are sent intraday to each purchased traffic source for ads that have reached their daily expected traffic. These pause requests stop the ad from getting any more impressions, and generating traffic or consuming budget, from purchased traffic sources. The time at which the pause request is sent is an input to 703. If the pause request is sent before close-of-business for an advertiser it will act to reduce or dampen future volume requests. If the pause request is sent after close-of-business it will act to increase or heighten future volume requests.

Referring to FIG. 7(b) for the details of the purchased traffic volume request in 703, 709 takes as inputs the cumulative traffic volume, revenue per visitor and cost per visitor for each traffic source. These inputs are used to compute the cumulative profit for each traffic source in 711 and to compute the marginal profit for each traffic source in 713. The non-purchased traffic source with the lowest marginal profit is selected in 715 and if that marginal profit equals the purchased traffic marginal profit in 717 then 721 outputs the current purchased traffic volume request. If the marginal profit is not equal to the purchased traffic marginal profit, then in 719 if it is greater, the purchased traffic volume is incremented and if it is less the volume is decremented. Control is returned to 711 and the process repeats until the termination condition is met in 717.

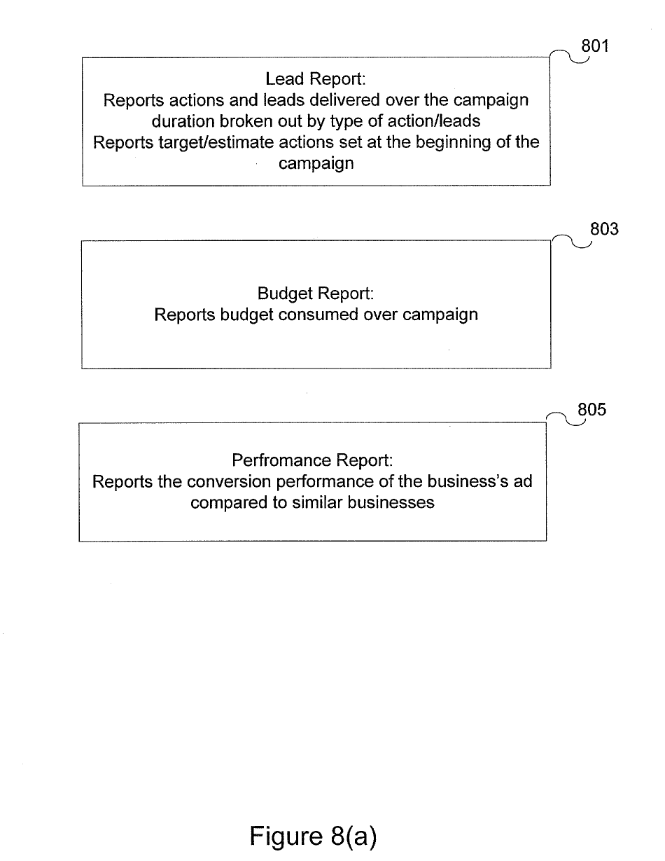

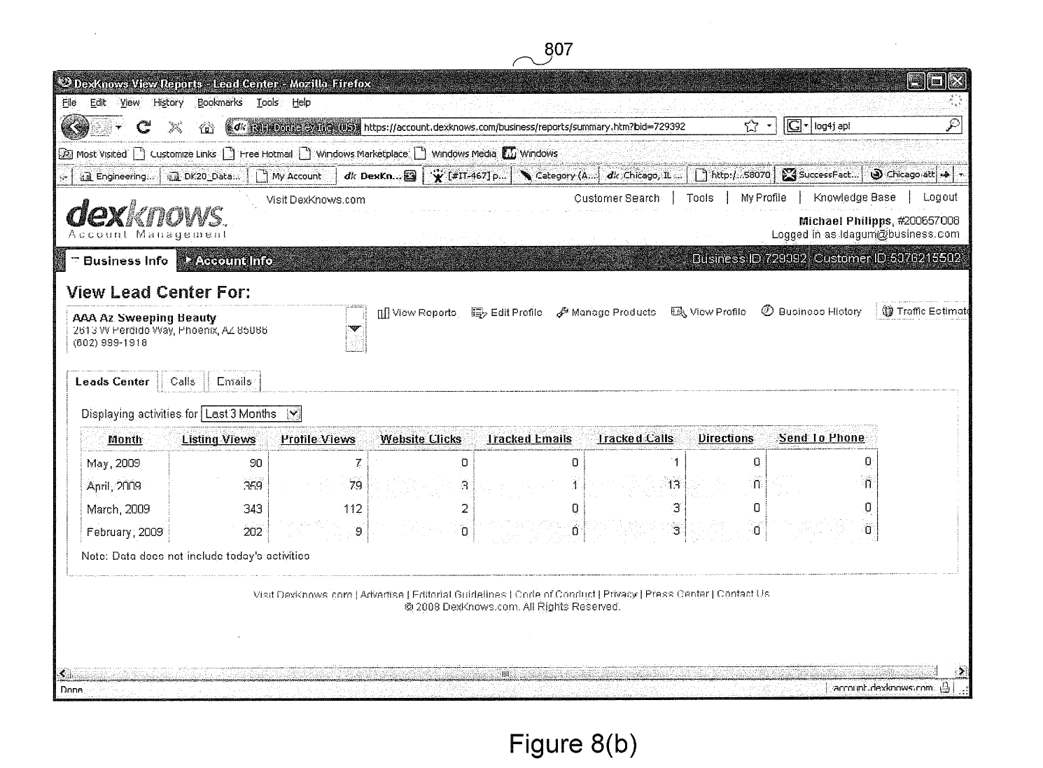

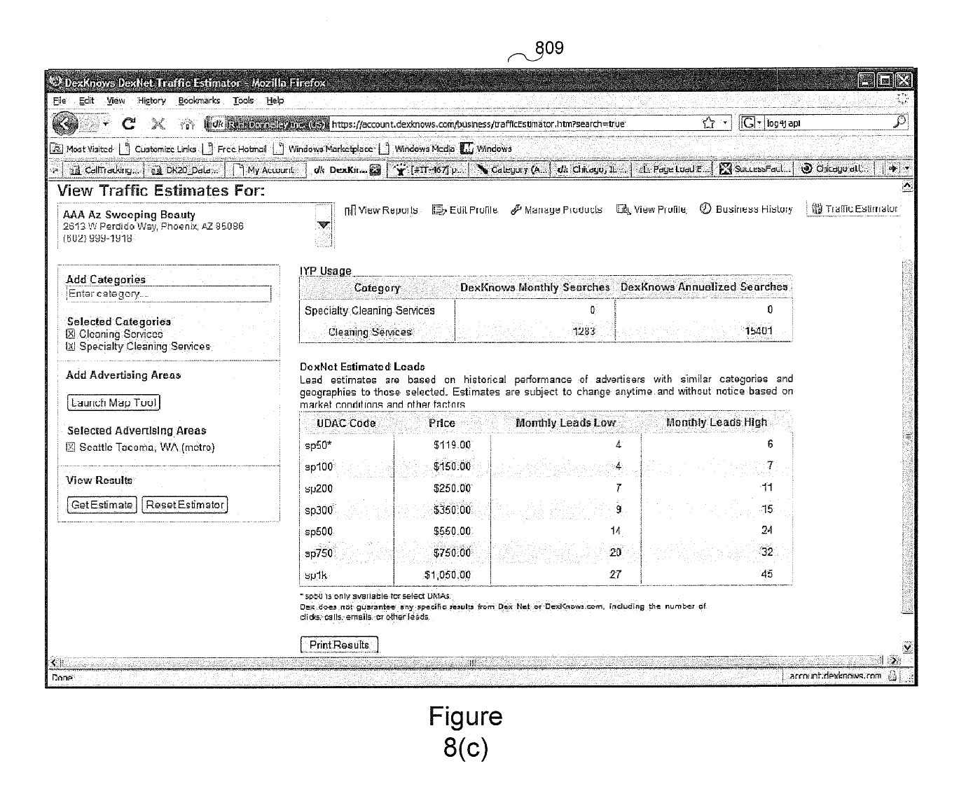

FIG. 8(a) illustrates an embodiment of the reporting module configured in accordance with the present invention and is not intended to limit scope as one of ordinary skill would understand on review of this application that other configurations could be utilized without departing from the scope of the claimed invention. In reference to FIG. 8(a), the reporting module comprises the lead report 801, the budget report 803, and the performance report 805. The reports are updated daily. The lead report contains the running total of all actions and leads delivered by campaign and aggregated by action type and lead type. The report also contains the lead estimates delivered during campaign creation. The budget report contains a daily snap-shot of the budget consumed and the remaining available budget. The performance report compares the ad listing's and business profile's conversion rate to leads and actions to the average conversion rates for each geo-category-attribute target. The business user can use this report to gain insight on whether her products and services are relevant to those targets and to optimize her campaign creatives and targeting.

FIG. 8(b)-(c) illustrate example lead reports configured in accordance with the present invention and is not intended to limit scope as one of ordinary skill would understand on review of this application that other configurations could be utilized without departing from the scope of the claimed invention. In reference to FIG. 8(b), the example lead report 807 for business AAA Az Sweeping Beauty contains the number monthly ad listing views, business profile views, clicks to website, tracked calls, tracked emails, direction views, and send-to-phone. The lead estimates provided to AAA Az Sweeping Beauty during campaign creation are shown in 809. Monthly leads low and a monthly leads high estimates are provided at varying budgets.

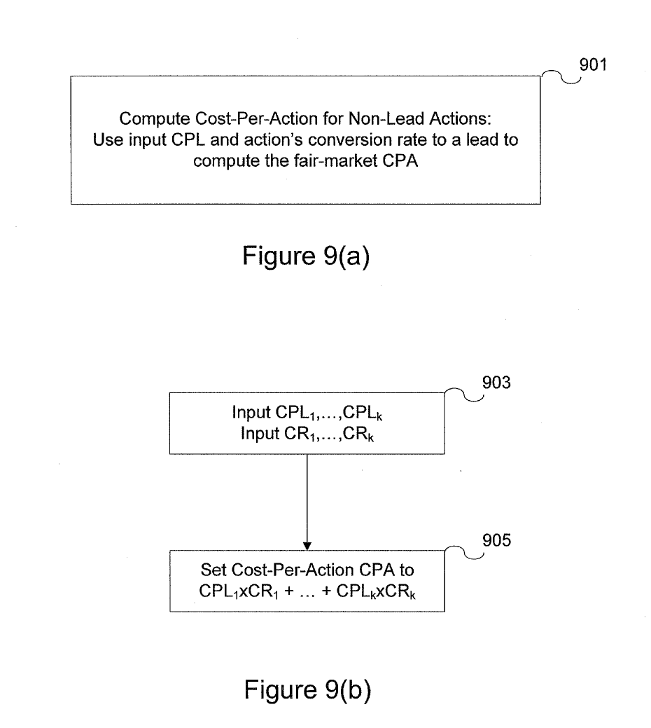

FIG. 9(a)-(b) illustrate an embodiment of the pricing module configured in accordance with the present invention and is not intended to limit scope as one of ordinary skill would understand on review of this application that other configurations could be utilized without departing from the scope of the claimed invention. The pricing module 901 computes the prices of leads and actions used to decrement budgets. Lead prices are the cost-per-leads (CPLs) which are inputs to the present invention. When a lead is generated directly from an ad listing displayed on a partner site or a search marketing site, the appropriate CPL price that corresponds to that lead type, the originating geo-category-attribute target, and originating source is used to decrement the business user's budget. When a click to a business profile or website is generated from the ad listing, the price for that click is computed by the pricing module and the budget decremented accordingly. Referring to FIG. 9(b), for a click action the price computation in 903 takes as input the CPLs of all lead actions available to the user after she clicks, and the average lead conversion rates CRs specific to the traffic source and target for each of the available lead actions. In 905 the cost-per-action price is computed by first multiplying the CPLs by their corresponding conversation rates CRs and then summing these values. Note that the CPA for an action depends on the traffic source. For example, consider a user who clicks on the click-to-profile link of an ad listing displayed on traffic source S. Assume the profile has a call number and an email link with a CostPerCall value of $20 and a CostPerEmail value of $10 for that geo-vertical. The user lands on the business profile and can generate a lead to the business owner by making a call or sending an email. The conversion rate for each of these events will depend on the traffic source S. If for S the average call-through-rate is 0.1 and the average email-through-rate is 0.05, the CostPerAction (click-to-profile in this case) is $20×0.1+$10×0.05=$2.50.

The various embodiments of the system and method for enabling a business owner to receive leads and examples thereof shown above illustrate a novel system and method for managing an internet based advertisement campaign. A user of the present invention may choose any of the above embodiments, or an equivalent thereof, depending upon the desired application. In this regard, it is recognized that various forms of the subject system and method could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. A computer implemented method for managing delivery of leads to a business, said method comprising the steps of:
creating an advertising campaign by entering data into a computer where said data includes campaign details for a campaign targeting information parameter, a campaign distribution information parameter, a campaign budget information parameter, a campaign duration parameter, an advertisement with a lead reference, and an ad-listing with a URL that links to said advertisement;
formulating a cost-per-lead parameter based on geographic, category and attribute targeting selected from geographic, category and attribute taxonomies;
syndicating the ad-listing to an internet site;
monitoring leads received by an advertiser from the lead reference;
decrementing the campaign budget information parameter for each click on the ad-listing URL by a product of the cost-per-lead and an advertisement's conversion rate of clicks to leads; and
purchasing traffic from search engines to the advertisement to generate leads and spend any remaining budget.

2. The computer implemented method of claim 1 wherein the ad-listing contains an ad lead reference, distinct from the lead reference of the advertisement, where said method further comprises the steps of
monitoring the leads received by the advertiser from the ad lead reference; and
decrementing the campaign budget by a cost-per-lead amount for each lead received from the ad lead reference.

3. The computer implemented method of claim 1, wherein the lead reference is selected from a list of lead references consisting of a phone number and an email address.

4. The computer implemented method of claim 1, wherein leads comprise any of phone calls, text messages, emails, digital lead forms, or facsimile lead forms.

5. The computer implemented method of claim 1 wherein multiple ad listings in a display are ordered based on their performance, consumed budget, remaining budget, and remaining campaign duration.

6. The computer implemented method of claim 1 further comprising generating and presenting a report on a number of leads delivered and budget consumed.

7. The computer implemented method of claim 1 wherein said data entered includes campaign details for a business name parameter, a business location parameter, a tag line, and a brief description of the business including any key areas of specialization.

8. The computer implemented method of claim 7 wherein said data entered is used for constructing the ad-listing that is displayed on the internet site.

9. The computer implemented method of claim 7 wherein said data entered is used for constructing a business profile.

10. The computer implemented method of claim 7, wherein the step of creating the advertising campaign can include reporting estimates of a number of leads to expect from the advertising campaign.

11. The computer implemented method of claim 7, further comprising the step of:
mapping geography, category and attribute to a target found to generate traffic where said target is purchasable from a search marketing source.

12. The computer implemented method of claim 11, where said purchasable target is keyworded with a set of keyphrases that are descriptive of the target's geography, category and attribute such that when a user selects a geography, category and attribute during campaign creation, the advertisement for the target inherits the purchasable target and keyphrases.

13. A computer system including a processor, a memory unit operable for storing a computer program, an input mechanism operable for inputting data into said computer system, an output mechanism for presenting information to a user, a bus coupling the processor to the memory unit, input mechanism and output mechanism, wherein the computer system includes various executable program modules stored thereon where when executed are operable to perform functions, said computer system comprising:
a campaign creation program module stored on a computer system where when executed allows a user to create an advertising campaign by entering data into the computer system where said data includes campaign details for a campaign targeting information parameter, a campaign distribution information parameter, a campaign budget information parameter, a campaign duration parameter, an advertisement with a lead reference, and an ad-listing with a URL that links to said advertisement;
an optimization module stored on said computer system where when executed formulates a cost-per-lead parameter based on geographic, category, lead type, originating source and attribute targeting selected from geographic, category and attribute taxonomies;
an internet distribution program module stored on said computer system where when executed allows the user to syndicate the ad-listing to an internet site;
a reporting program module stored on said computer system where when executed allows the user to monitor leads received by an advertiser from each lead reference;
an optimization program module stored on said computer system where when executed decrements the campaign budget information parameter for each click on an ad-listing URL by a product of the cost-per-lead parameter and an advertisement's conversion rate of clicks to leads; and
a purchased traffic program module stored on said computer system where when executed allows the user to purchase traffic from search engines to the advertisement to generate leads and spend any remaining budget.

14. The computer system of claim 13 wherein the ad listing contains an ad lead reference, distinct from the lead reference of the advertisement, said computer system further comprising:
a reporting program module stored on said computer system where when executed allows the user to monitor leads received by an advertiser from the ad lead reference; and
an optimization program module stored on said computer system where when executed decrements the campaign budget by a cost-per-lead amount for each lead received from the ad lead reference.

15. The computer system of claim 13, wherein the lead reference is a phone number or email address

16. The computer system of claim 13, wherein leads are selected from a group consisting of phone calls, text messages, emails, digital lead forms, and facsimile lead forms.

17. The computer system of claim 13, wherein if multiple ad-listings are displayed by the reporting program module, the purchased traffic program module is further operable to order the ad listings based on their performance, consumed budget, remaining budget, and remaining campaign duration.

18. The computer system of claim 13, wherein the reporting program module is further operable to report on a number of leads delivered and budget consumed.

19. The computer system of claim 13, wherein said data entered includes campaign details for a business name parameter, a business location parameter, a tag line, and a brief description of a business including any key areas of specialization.

20. The computer system of claim 13, wherein said data entered is used for constructing the ad-listing that is displayed on the internet site.

21. The computer system of claim 13, wherein said data entered is used for constructing a business profile.

22. The computer system of claim 13, wherein the campaign can include reporting estimates of a number of leads to expect from the advertising campaign.

23. The computer system of claim 13, further comprising:
geography, category and attribute mapped to a target found to generate traffic where said target is purchasable from a search marketing source.

24. The computer system of claim 13, where said purchasable target is keyworded with a set of keyphrases that are descriptive of the target's geography, category and attribute such that when a user selects a geography, category and attribute during campaign creation, the advertisement for the target inherits the purchasable target and keyphrases.

25. A computer implemented method for managing delivery of leads to a business, said method comprising the steps of:
creating an advertising campaign by entering data into a computer where said data includes campaign details for a campaign targeting information parameter, a campaign distribution information parameter, a campaign budget information parameter, a campaign duration parameter, an advertisement with a lead reference, and an ad-listing with a URL that links to said advertisement;
formulating a cost-per-lead parameter based on geographic, category and attribute targeting selected from geographic, category and attribute taxonomies;
syndicating the ad-listing to an internet site;
monitoring leads received by an advertiser from the lead reference;
decrementing the campaign budget information parameter for each click on the ad-listing URL by a product of the cost-per-lead parameter and an advertisement's conversion rate of clicks to leads; and
purchasing traffic from search engines to the advertisement to generate leads and spend any remaining budget,
where the cost-per-lead parameter depends on a specific geo-vertical and lead type and computed using data sources to triangulate to a geo-vertical cost-per-lead, where the data sources are selected from a group of data sources consisting of Search-Engine cost-per-click data, internet yellow pages cost and conversation data, and market research data.

26. The computer implemented method as recited in claim 25, where triangulating to a geo-vertical cost-per-lead is to combine the data sources into a single cost-per-lead for a specific lead type where each data source is weighted relative to volume of leads delivered by each source.

27. The computer implemented method as recited in claim 26, further comprising the steps of:
receiving a message request from a host of the internet site, which includes an id identifying the data source, a taxonomy geography, category and attribute, and a number of ad listings; and
sending a message response including ad-listings, ad-listing display order that defines an order in which the ad-listings are arranged.

28. The computer implemented method as recited in claim 26, further comprising the steps of:
mapping the taxonomy geographies, categories and attributes to targets that are purchasable for each purchasable marketing source.
